(19) United States
(12) Patent Application Publication
(10) Pub. No.: US 2009/0213755 A1
(43) Pub. Date: Aug. 27, 2009

(54) METHOD FOR ESTABLISHING A ROUTING MAP IN A COMPUTER SYSTEM INCLUDING MULTIPLE PROCESSING NODES

(76) Inventor: Yinghai Lu, Santa Clara, CA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 12/037,224

(22) Filed: Feb. 26, 2008

(51) Int. Cl. H04L 12/28

(52) U.S. Cl. 370/254

(57) ABSTRACT

A method for establishing a routing map of a computer system including a plurality of nodes interconnected by a plurality of physical links includes beginning with a first node, iteratively determining link information corresponding to each physical link of each node. In response to determining the link information for each node, sequentially numbering each node excepting the first node. The method may also include maintaining the link information and associated node number information in a data structure, and assigning node groups based upon which nodes are physically connected together. The method may further include determining a correct node numbering based upon the node groups such that the node numbers are contiguous in each grouping of nodes, and from one group of nodes to a next group of nodes, and updating the data structure based upon the correct node numbering.

### BACKGROUND OF THE INVENTION

1. Field of the Invention

This invention relates to multiprocessing systems and, more particularly, to routing table setup for a multi-node computing system.

2. Description of the Related Art

Multi-node processing systems such as symmetric multi-processing (SMP) systems, for example, have been around for quite some time. In the past, such systems may have included two or more computing nodes, each with a single central processing unit, that share a common main memory. However, as chip multiprocessors are gaining popularity a new type of computing platform is emerging. These new platforms include processing nodes with multiple processors in each node. Many of these nodes have multiple communication interfaces for communicating with multiple nodes to create a vast network fabric using no switches. For example, some of these systems use cache coherent communication links such as HyperTransport™ links, for example, for internode communication. Depending on the number of internode links and the routing rules for the network of nodes, establishing a routing table for each node in the system can be a complex task, particularly when the basic input output system (BIOS) does not have system topology information.

### SUMMARY

Various embodiments of a method and system for establishing a routing map of a computer system including a plurality of nodes interconnected by a plurality of physical links are disclosed. A method is contemplated that establishes a routing map for a computer system that includes many nodes, and in which the topology of the computer system may not be known to the bootstrap node at system start up. Accordingly, in one embodiment, the method includes beginning with a first node of the plurality of nodes, and iteratively determining link information corresponding to each physical link of each node of the plurality of nodes. In response to determining the link information for each node, sequentially numbering each node excepting the first node. The method may also include maintaining the link information and associated node number information in a data structure, and assigning node groups based upon which nodes are physically connected together such that no node belonging to one group belongs to another group. The method may further include determining a correct node numbering based upon the node groups such that the node numbers are contiguous in each grouping of nodes, and from one group of nodes to a next group of nodes, and updating the data structure based upon the correct node numbering.

In another embodiment a computer system includes a plurality of processing nodes interconnected via a plurality of physical links, and a storage medium coupled to a particular node of the plurality of processing nodes and configured to store initialization program instructions. The particular node may establish a routing map corresponding to an interconnection of the plurality of processing nodes by executing the initialization program instructions. To establish the routing map, the particular node may begin with a first node such as a bootstrap node, for example, and iteratively determine link information corresponding to each physical link of each node of the plurality of nodes. In addition the first node may sequentially number each node (e.g., node ID) excepting the first node, in response to determining the link information for each node. The first node may also maintain the link information and associated node number information in a data structure and assign node groups based upon which nodes are physically connected together such that no node belonging to one group belongs to another group. The first node may also determine a correct node numbering based upon the node groups such that the node numbers are contiguous in each grouping of nodes, and from one group of nodes to a next group of nodes. The first node may further update the data structure based upon the correct node numbering.

### BRIEF DESCRIPTION OF THE DRAWINGS

FIG. 1 is a block diagram of an embodiment of a single-node computer system.

FIG. 2A is a diagram illustrating an embodiment of multi-node computer system with eight nodes.

FIG. 3 is a flow diagram describing operation of the an embodiment of a multi-node computer system.

FIG. 4 is a diagram illustrating an embodiment of a multi-node computer system with 32 nodes.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

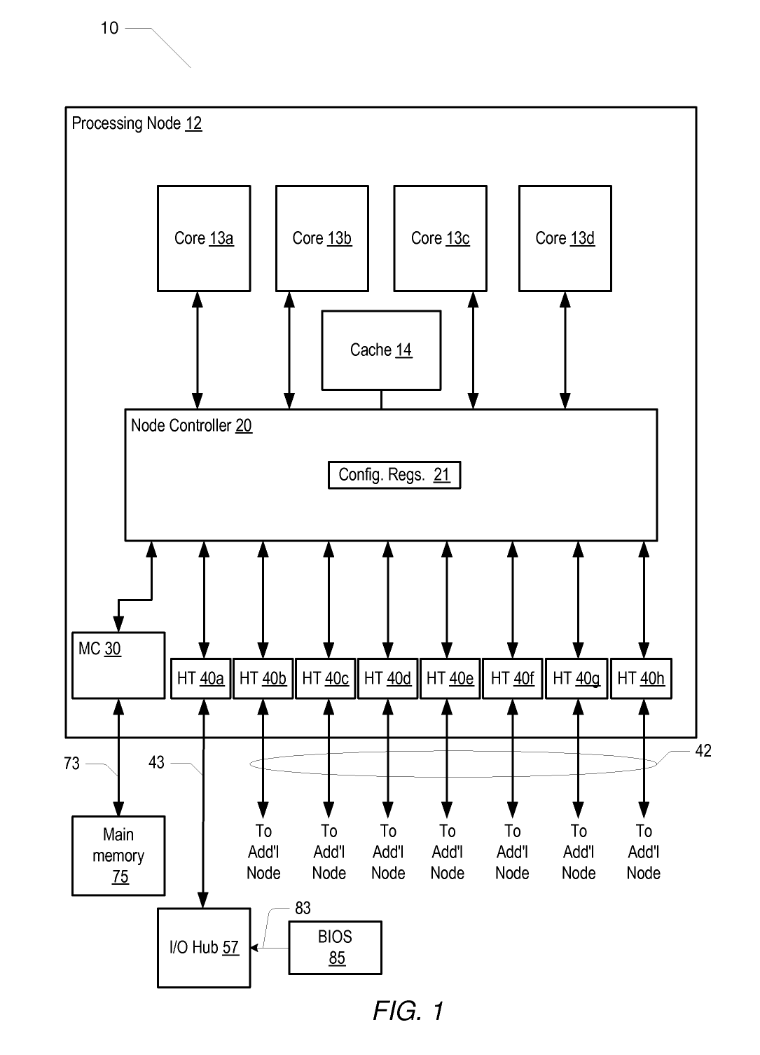

Turning now to FIG. 1, a block diagram of one embodiment of a computer system with one processing node is shown. The computer system 10 includes a processing node 12 that is coupled to a main memory 75, and to an I/O hub 57. The I/O hub 57 is also coupled to a BIOS storage 85 via a peripheral bus 85. It is noted that components that have reference designators having a number and a letter may be referred to by the number alone where appropriate. Processing node 12 includes four processor cores, designated 13a though 13d that are coupled to a node controller 20, which is in turn coupled to a shared cache memory 14, a memory controller, designated MC 30, and a number of communication interfaces, designated HT 40a through HT 40h. It is noted that although four processor cores are shown, it is contemplated that processing node 12 may include any number of processor cores in other embodiments. In one embodiment, processing node 12 may be a single integrated circuit chip comprising the circuitry shown therein in FIG. 1. That is, processing node 12 may be a chip multiprocessor (CMP). Any level of integration or discrete components may be used.

Generally, a processor core (e.g., processor cores 13) may include circuitry that is designed to execute instructions defined in a given instruction set architecture. That is, the processor core circuitry may be configured to fetch, decode, execute, and store results of the instructions defined in the instruction set architecture. For example, in one embodiment, processor cores 13 may implement the x86 architecture. The processor cores 13 may comprise any desired configurations, including superpipelined, superscalar, or combinations thereof. It is noted that processing node 12 and processor cores 13 may include various other circuits that have been omitted for simplicity. For example, various embodiments of processor cores 13 may implement a variety of other design features such as level 1 (L1) and level two (L2) caches, translation lookaside buffers (TLBs), etc.

In one embodiment, cache 14 may be a level 3 (L3) cache, that may be shared by processor cores 13a-13d, as well as any other processor cores in other nodes (not shown in FIG. 1). In various embodiments, cache 14 may be implemented using any of a variety of random access memory (RAM) devices. For example, cache memory 14 may be implemented using devices in the static RAM (SRAM) family.

In various embodiments, node controller 20 may include a variety of interconnection circuits (not shown) for interconnecting processor cores 13a-13d to each other, to other nodes, and to memory 75. Node controller 20 may also include functionality for selecting and controlling, via configuration registers 21, various node properties such as the node ID, memory addressing, the maximum and minimum operating frequencies for the node and the maximum and minimum power supply voltages for the node. In addition, configuration register settings may determine which processing node is the boot-strap node, in a multi-node system. The node controller 20 may generally be configured to route communications between the processor cores 13a-13d, the memory controller 30, and the HT interfaces 40a-40h dependent upon the communication type, the address in the communication, etc. In one embodiment, the node controller 20 may include a system request queue (SRQ) (not shown) into which received communications are written by the node controller 20. The node controller 20 may schedule communications from the SRQ for routing to the destination or destinations among the processor cores 13a-13d, and the memory controller 30. In addition, a routing table may be used for routing to the HT interfaces 40a-40h.

Generally, the processor cores 13a-13d may use the interface(s) to the node controller 20 to communicate with other components of the computer system 10 (e.g. I/O hub 57, other processor nodes (not shown in FIG. 1), the memory controller 30, etc.). The interface may be designed in any desired fashion. Cache coherent communication may be defined for the interface, in some embodiments. In one embodiment, communication on the interfaces between the node controller 20 and the processor cores 13a-13d may be in the form of packets similar to those used on the HT interfaces. In other embodiments, any desired communication may be used (e.g. transactions on a bus interface, packets of a different form, etc.). In other embodiments, the processor cores 13a-13d may share an interface to the node controller 20 (e.g. a shared bus interface). Generally, the communications from the processor cores 13a-13d may include requests such as read operations (to read a memory location or a register external to the processor core) and write operations (to write a memory location or external register), responses to probes (for cache coherent embodiments), interrupt acknowledgements, and system management messages, etc.

In one embodiment, the communication interfaces HT 40a-HT 40h may be implemented as HyperTransport™ interfaces. As such, they may be configured to convey either coherent or non-coherent traffic. As shown in FIG. 1, HT 40a is coupled to I/O hub 57 via link 43. Accordingly, link 43 may be implemented as a non-coherent HT link, and HT 40a may be configured as a non-coherent HT interface. In contrast, each of interfaces 40b-40h may be configured as coherent HT interfaces and links 42 may be coherent HT links for connection to other processing nodes. In either case, the interfaces HT 40a-HT 40h may comprise a variety of buffers and control circuitry for receiving packets from an HT link and for transmitting packets upon an HT link. A given HT interface 40 comprises unidirectional links for transmitting and receiving packets. Each HT interface 40a-HT 40h may be coupled to two such links (one for transmitting and one for receiving). In the illustrated embodiment, processing node 12 includes eight HT interfaces. However, in other embodiments, processing node 12 may include any number of HT interfaces.

The main memory 75 may be representative of any type of memory. For example, a main memory 75 may comprise one or more random access memories (RAM) in the dynamic RAM (DRAM) family such as RAMBUS DRAMs (RDRAMs), synchronous DRAMs (SDRAMs), double data rate (DDR) SDRAM. Alternatively, memory 14 may be implemented using static RAM, etc. The memory controller 30 may comprise control circuitry for interfacing to the main memory 75. Additionally, the memory controller 30 may include request queues for queuing memory requests, etc. As such memory bus 73 may convey address, control and data signals between main memory 75 and memory controller 30.

In the illustrated embodiment, I/O hub 57 is coupled to BIOS 85 via peripheral bus 83. Peripheral bus 85 may be any type of peripheral bus such as an low pin count (LPC) bus, for example. I/O hub 57 may also be coupled to other types of buses and other types of peripheral devices. For example, other types of peripheral devices may include devices for communicating with another computer system to which the devices may be coupled (e.g. network interface cards, circuitry similar to a network interface card that is integrated onto a main circuit board of a computer system, or modems). Furthermore, the peripheral devices may include video accelerators, audio cards, hard or floppy disk drives or drive controllers, SCSI (Small Computer Systems Interface) adapters and telephony cards, sound cards, and a variety of data acquisition cards such as GPIB or field bus interface cards. It is noted that the term “peripheral device” is intended to encompass input/output (I/O) devices.

In various embodiments, BIOS 85 may be any type of non-volatile storage for storing program instructions used by a bootstrap processor (BSP) core during node (and/or system) initialization after a power up or a reset, for example. As described in greater detail below, in a computer system that includes many nodes, the BSP node/core may not have any information about the topology of the processing nodes 12 in the system. Accordingly initializing program instructions, when executed by the BSP core, may create a routing or mapping table by determining all the nodes in the system, and how they are physically connected. In addition, the program instructions may number all the nodes such that the node ID numbers are contiguous within a grouping of nodes, from group to group, and from plane to plane. It is noted that in one embodiment, the initializing program instructions may be part of the BIOS code stored within BIOS 85. However, it is contemplated that in other embodiments, the initializing program instructions may be part of other system software such as a module of the operating system (OS), for example. Alternatively, the initializing program instructions may be part of a specialized kernel that establishes the routing table/mapping and then loads the normal OS. It is noted that for embodiments in which the initializing program instructions reside in the BIOS storage 85, they may be transferred to BIOS storage 85 in a variety of ways. For example the BIOS storage 85 may be programmed during system manufacture, or the BIOS storage 85 may be programmed at any other time depending on the type of storage device being used. Further, the program instructions may be stored on any type of computer readable storage medium including read only memory (ROM), any type of RAM device, optical storage media such as compact disk (CD) and digital video disk (DVD), RAM disk, floppy disk, hard disk, and the like.

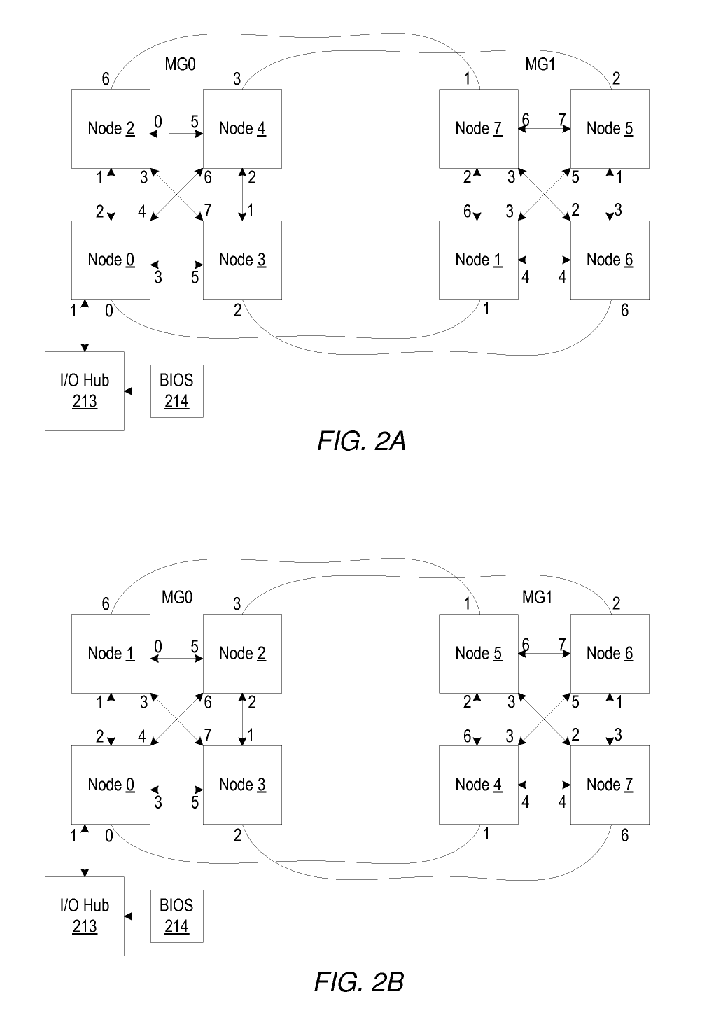

In multi-node computer systems, the nodes may be configured into groups of two or more nodes, and planes with two or more groups. So a system may have a topology defined by N×G×P, where N is the number of nodes in a group, G is the number of groups in a plane, and P is the number of planes. Thus, a 4×2×2 system would include four nodes per group, two groups per plane, and two planes. Certain system topology routing rules may require that the nodes be numbered (i.e., node ID values) sequentially and contiguously within a group, from group to group, and plane to plane. FIG. 2A depicts a simple 4×2×1 computer system with eight nodes during initialization and prior to finalizing the routing table. FIG. 2B depicts the eight-node computer system of FIG. 2A after the routing table has been finalized and the nodes numbered correctly.

Referring to FIG. 2A, the computer system includes eight nodes arranged in a 4×2×1 arrangement. It is noted that each node of FIG. 2A may correspond to the processing node 12 shown in FIG. 1. Node 0 is coupled to an I/O hub 213, which is coupled to a BIOS 214. As such, node 0 is the designated BSP node for this system. As shown, each node is numbered with a node ID, and each node is coupled to four other nodes via links that are also numbered. As shown, the nodes in FIG. 2A are not numbered sequentially and contiguously in the right hand or the left hand groups, and not between the groups. Thus the node numbering does not follow the routing rules. This numbering arrangement may correspond to an interim numbering that may be used during an initialization sequence as described further below. In one embodiment, each of the links (with the exception of link 1, which is a non-coherent link) corresponds to one of the coherent HT links 42 of FIG. 1. In one embodiment, during system initialization the designated core in the BSP node (node 0) may execute the initializing code. Configuration registers 21 within the node controller 20 of FIG. 1 may include a node ID register that may have a node ID value that identifies the node number of the node within the system. In one embodiment the BSP node may have a node ID of zero, and every other node in the system may have a default value of 07h, for example, coming out of reset.

During initialization, while executing initializing code, node 0 may be configured to determine the system topology by systematically checking each of its HT links 40 to determine whether each link is coupled to another node, and if so, to also determine the link number of the return link. As described further below, node 0 may maintain one or more data structures (e.g., Table 1 through Table 4) to record the link/node relationships.

As described above, each HT link includes a pair of unidirectional links, one inbound and one outbound. In one embodiment, each node may know the link number of it's outbound link (source node link) since that may be established by the that node, but not the link number of the return or inbound link. Thus to determine target link and target node information, node 0 may send a request packet out and wait a predetermined amount of time for a response. If a response is received, the response includes the link number for that inbound link. If no response is received after a predetermined number of retries or elapsed time, that link may be designated as unconnected.

Once node 0 has determined that a given link is connected to a node, the appropriate data structure may be updated to include the return link and target node information. Node 0 may then program the node ID of the newly found node by writing to the node ID register (not shown) of configuration registers 21 in that new node. Node 0 may number each node sequentially as it discovers each new node. An exemplary data structure is shown in Table 1.

The data structure of Table 1 depicts an 8×8 link to node matrix that illustrates the relationship between the source node and the links of the source node, and the target (node to which each node is connected) and by which return link. Thus the rows represent Source node IDs, and the columns represent the link numbers for each source node. Each matrix location represents the target node/return link. For example, in Table 1, the matrix location at the intersection of Node 0: link 0 has an entry of 1/1. The 1 on top denotes node 1, and the 1 on the bottom denotes link 1. This would be interpreted as link 0 of node 0 is connected to node 1, and the return link from node 1 to node 0 is link 1.

TABLE 1
Initial link to node matrix

| | Link # | | | | | | | |
|---|---|---|---|---|---|---|---|---|
| | 0 | | | | | | | |
| Node # | node/rln | 1 | 2 | 3 | 4 | 5 | 6 | 7 |
| 0 | 1/1 | NU | 2/1 | 3/5 | 4/6 | NU | NU | NU |
| 1 | NU | 0/0 | NU | 5/5 | 6/4 | NU | 7/2 | NU |
| 2 | 4/5 | 0/2 | NU | 3/7 | NU | NU | 7/1 | NU |
| 3 | NU | 4/2 | 6/6 | NU | NU | 0/3 | NU | 2/3 |
| 4 | NU | NU | 3/1 | 5/2 | NU | 2/0 | 0/4 | NU |
| 5 | NU | 6/3 | 4/3 | NU | NU | 1/3 | NU | 7/6 |
| 6 | NU | NU | 7/3 | 5/1 | 1/4 | NU | 3/2 | NU |
| 7 | NU | 2/6 | 1/6 | 6/2 | NU | NU | 5/7 | NU |

Another exemplary data structure is shown in Table 2. The data structure of Table 2 depicts an 8×8 link to node matrix that illustrates the relationship between the source node and the target node and which links connect the two nodes. Thus the rows represent source node IDs, and the columns represent target node IDs. Each matrix location represents the outbound/inbound link for the source node. For example, in Table 2, the matrix location at the intersection of SNode 0: TNode 1 has an entry of 0/1. The 0 on top denotes outbound link 1, and the 1 on the bottom denotes return link 1. This would be interpreted as node 0 is connected to node 1 by link 0 and the return link from node 1 to node 0 is link 1.

TABLE 2
Initial link to target node matrix

| | TNode # | | | | | | | |
|---|---|---|---|---|---|---|---|---|
| | 0 | | | | | | | |
| SNode # | oln/rln | 1 | 2 | 3 | 4 | 5 | 6 | 7 |
| 0 | — | 0/1 | 2/1 | 3/5 | 4/6 | — | — | — |
| 1 | 1/0 | — | — | — | — | 3/5 | 4/4 | 6/2 |
| 2 | 2/1 | — | — | 3/7 | 0/5 | — | — | 6/1 |
| 3 | 5/3 | — | 7/3 | — | 1/2 | — | 2/6 | |
| 4 | 6/4 | — | 5/0 | 2/1 | — | 3/2 | — | — |
| 5 | — | 5/3 | — | — | 2/3 | — | 1/3 | 7/6 |
| 6 | — | 4/4 | — | 6/2 | — | 3/1 | — | 2/3 |
| 7 | — | 2/6 | 1/6 | — | — | 6/7 | 3/2 | — |

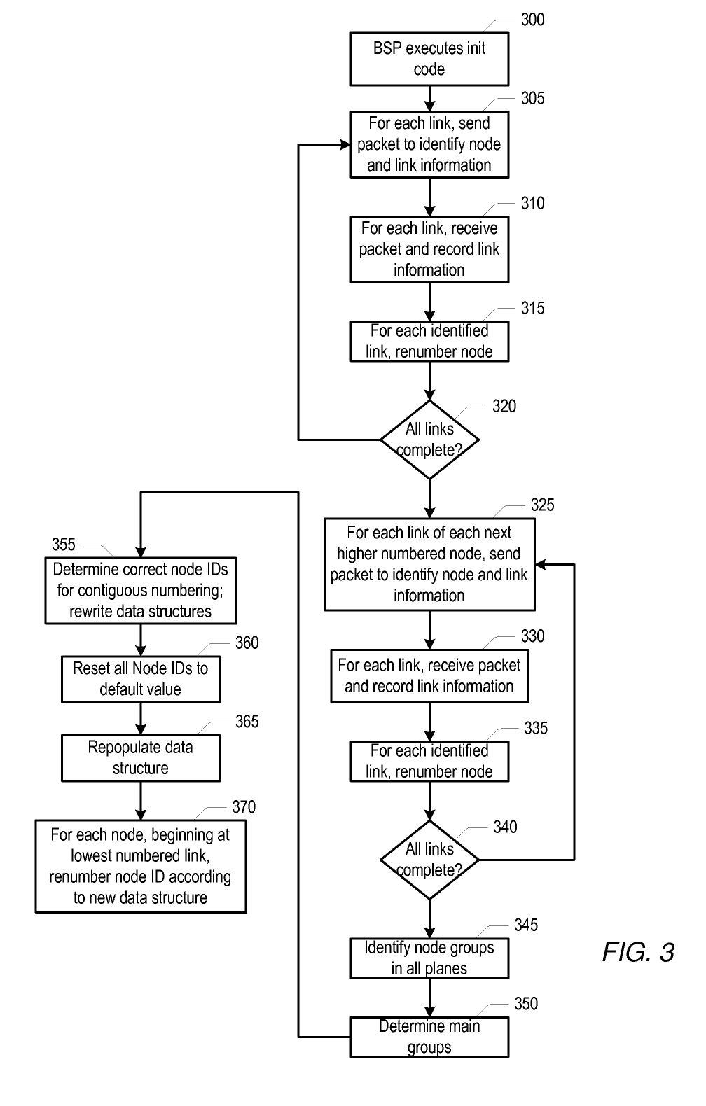

FIG. 3 is a flow diagram that describes the operation of an embodiment of a processing node executing the initializing code when setting up the routing table. More particularly, blocks 300 through 340 describe the operation of node 0 establishing the interim node numbering corresponding to FIG. 2A, and Tables 1 and 2, while blocks 345 through 370 describe the operation of node 0 in establishing the node numbering corresponding to FIG. 2B.

Referring collectively to FIG. 2A, FIG. 3, Table 1, and Table 2, and beginning in block 300 of FIG. 3. After a system reset or power-on reset condition, the BSP processor core within the BSP node (e.g., node 0) executes initializing program instructions, which in one embodiment may be stored within BIOS storage 214. The initializing program instructions, when executed, cause the BSP node to determine the topology of the computer system and to create a routing table. The BSP checks each communication link by sending a request packet on the outbound link (block 305). In one embodiment, the BSP may start with the lowest numbered link and then sequentially check each link. For example, in FIG. 2A, node 0 may start at link 0 by sending the request packet. Since link 0 is connected to a node, a response is received and that response would include the return link number. Node 0 may record the link and node information in the appropriate data structures (block 310). Node 0 may then send a control packet to program the node ID register with a value of 1, thus making that node, node 1 (block 315). If all links have not been checked (block 320), node 0 continues checking each link as described above in block 305.

However, once all node 0 links have been checked (block 320), and all nodes connected to node 0 have been identified and numbered, node 0 may now check each link of each node to which node 0 is connected. For example, node 0 may send packets to node 1 requesting that node 1 check each of it's links sequentially beginning, at the lowest numbered link (block 325). Similarly, if response packets are received by node 1, and each other node, those response packets are forwarded to node 0, and node 0 records the node and packet information in both data structures (block 330). For example, node 1 may start at link 3, since link 1 is already mapped. Node 1 may send the request packet out link 3, and await a response. Since link 3 is connected to a node, the response will include link number 5 and other node information. The response information is forwarded to node 0, which records the link and node information in the data structures. Node 0 may then send a control packet that causes the node to be numbered as node 5, which is the next higher numbered node (block 335). If all links of each node connected to node 0 have not been checked (block 340), node 0 continues checking each link of each node connected to node 0 as described above in block 325.

However, once all node links of all nodes have been checked (block 340), and all nodes connected to node 0 have been identified and numbered, node 0 may gather link and node data from the data structures, which identifies how the nodes are physically connected, to identify node groups in all planes (block 345). For example, in FIG. 2A, according to routing rules the node groups should have at least two nodes. As such, in FIG. 2A, the groups may include {nodes 0,1}; {nodes 0, 2, 3, 4}; {nodes 1, 5, 6, 7}; {nodes 4, 5}; {nodes 2, 7}; and {nodes 3, 6}. If the system had multiple planes the groups would be identified for all planes. Once the groups have been identified, node 0 may determine which groups are the main groups (block 350). For example, to be selected as a main group, the group should have the number of nodes specified in the N×G×P requirement. The main groups may not include nodes that are in another main group. Thus, in FIG. 2A, the main groups would include the group including {nodes 1, 5, 6, 7} and the group including {nodes 0, 2, 3, 4}.

Using the main groups, node 0 determines the correct node numbering to conform to the routing rules and may then rewrite the appropriate data structure (e.g., table 1) to reflect the new routing (block 355). For example, main group 0 will include node 0. As such, to begin renumbering the nodes, node 0 may begin at the lowest link number for that main group (e.g., link 2). The node connected to it is node 2. However, the node connected to the lowest link number should be the next node number, which is node 1. Accordingly, node 0 may rewrite the data structures to show node 0: link 1 connected to node 1. The new routing information is shown in Table 3 below. Next node 0 may renumber the node connected to the new node 1 and to node 0 with the next higher node number (e.g., node 2). Again the data structure is updated to reflect the new routing information. These steps may be repeated for each node in each group, until all nodes are numbered to conform to the routing rules in the data structure. Once the nodes in the group are renumbered, node 0 may rewrite the data structure to reflect the renumbering of the nodes in the other main groups, if necessary. In the example of FIG. 2A, node 0 may renumber former node 1 to be node 4, which is the next highest number, and former node 7 to be node 5, and so on.

TABLE 3
Final link to node matrix

| | Link # | | | | | | | |
|---|---|---|---|---|---|---|---|---|
| | 0 | | | | | | | |
| Node # | node/rln | 1 | 2 | 3 | 4 | 5 | 6 | 7 |
| 0 | 4/1 | NU | 1/1 | 3/5 | 2/6 | NU | NU | NU |
| 1 | 2/5 | 0/2 | NU | 3/7 | NU | NU | 5/1 | NU |
| 2 | NU | NU | 3/1 | 6/2 | NU | 1/0 | 0/4 | NU |
| 3 | NU | 2/2 | 7/6 | NU | NU | 0/3 | NU | 1/3 |
| 4 | NU | 0/0 | NU | 6/5 | 7/4 | NU | 5/2 | NU |
| 5 | NU | 1/6 | 4/6 | 7/2 | NU | NU | 6/7 | NU |
| 6 | NU | 7/3 | 2/3 | NU | NU | 4/3 | NU | 5/6 |
| 7 | NU | NU | 5/3 | 6/1 | 4/4 | NU | 3/2 | NU |

Once the data structure has been rewritten to reflect correct node numbering within the groups and across the groups, node 0 may begin physically renumbering the node IDs. In one embodiment, node 0 may cause all node IDs to be reset to the default value (e.g., 07h) by sending control packets to reprogram the node ID register values of each node default values (block 360). Node 0 may rewrite the link to target node matrix (e.g., Table 4 below) to reflect the new routes (block 365). Node 0 may reprogram the node ID register values of each node as is shown in the link to target node data structure (block 360). The new node numbering is shown in FIG. 2B.

TABLE 4
Final link to target node matrix

| | TNode# | | | | | | | |
|---|---|---|---|---|---|---|---|---|
| | 0 | | | | | | | |
| SNode# | oln/rln | 1 | 2 | 3 | 4 | 5 | 6 | 7 |
| 0 | — | 2/1 | 4/6 | 3/5 | 0/1 | — | — | — |
| 1 | 2/1 | — | 0/5 | 3/7 | — | 6/1 | — | — |
| 2 | 6/4 | 5/0 | — | 21 | — | — | 3/2 | — |
| 3 | 5/3 | 7/3 | 1/2 | — | 2/6 | — | — | |
| 4 | 1/0 | — | — | — | — | 6/2 | 3/5 | 4/4 |
| 5 | — | 1/6 | — | — | 2/6 | — | 6/7 | 3/2 |
| 6 | — | — | 2/3 | — | 5/3 | 7/6 | — | 1/3 |
| 7 | — | — | — | 6/2 | 4/4 | 2/3 | 3/1 | — |

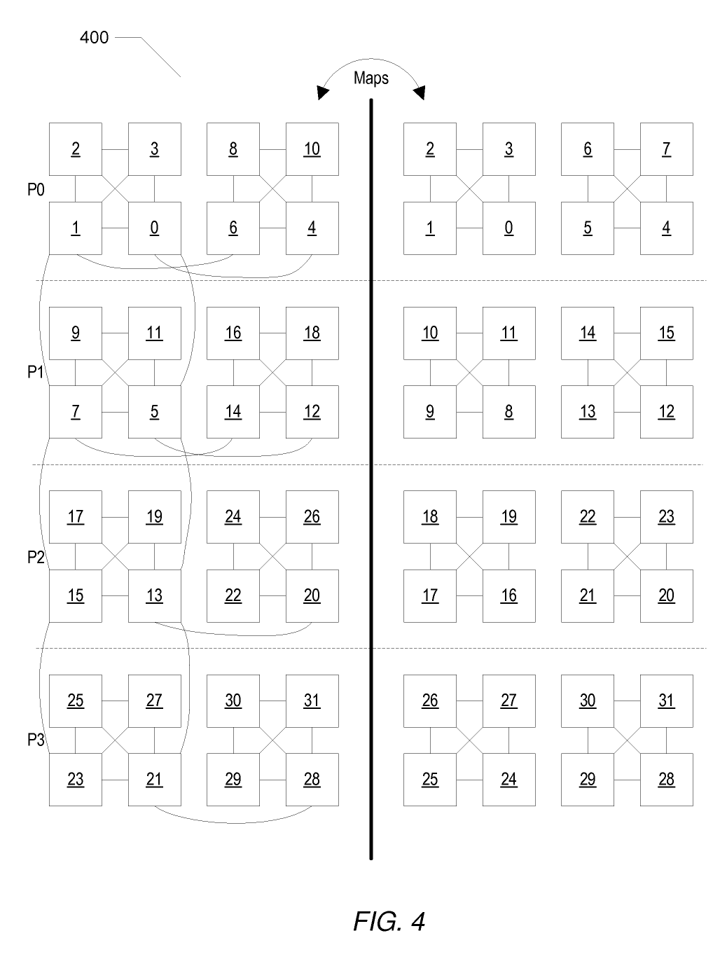

Turning to FIG. 4, a block diagram of one embodiment of a computer system having multiple nodes is shown. The computer system 400 includes 32 nodes arranged as a 4×2×4 system, which as described above, corresponds to four nodes per group, 2 groups per plane and four planes. In the illustrated embodiment, the nodes are physically connected between groups and planes as follows. In plane 0, node 0 is connected to nodes 1, 2, 3, and 4. Similarly, node 1 is connected to nodes 0, 2, 3, and 6. Node 0 is also connected to node 5 in plane 1, and node 1 is connected to node 7 in plane 1. Nodes 5 and 7 are connected to nodes 12 and 14, respectively, in plane 1. The remaining nodes are connected similarly. It is noted that although only 32 nodes are shown, any number of nodes, groups, and planes within the physical constraints of the system in which it is applied may be connected, and a routing table may be created for the system.

Similar to the system shown in FIG. 2A, the nodes on the left side of the thick vertical line of FIG. 4 are not numbered sequentially and contiguously. The nodes on the right side, however, are numbered sequentially and contiguously within each group, from group to group, and from plane to plane. Thus, when the BSP of system 400 (e.g., node 0) executes initializing code, the operation of node 0 as described in conjunction with the description of FIG. 3 may be used. Accordingly, node 0 may determine the topology of the system by systematically checking each link beginning in node 0 and working through each link of each node and recording the link and node relationships into various data structures, and temporarily numbering each node as shown on the left side of FIG. 4. Once all links are complete and all nodes are numbered, node 0 may determine the correct node ID numbering as required by routing rules, rewrite the appropriate data structure to reflect that correct numbering, and then reset all nodes to default values. Node 0 may then renumber the node IDs of all nodes according to the correct numbers in the data structure as shown on the right side of FIG. 4. Then node 0 may update the link to node data structure to reflect the new node numbering.

More particularly, in one embodiment, the operation described in conjunction with FIG. 4 just extends the operation described in conjunction with FIG. 3 to multiple planes. Thus, the operational steps may include more iterations for each node, since each node is connected to more nodes, and the data structures shown in Tables 1 through 4 may need to be extended to include the additional planes.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for establishing a routing map of a computer system including a plurality of nodes interconnected by a plurality of physical links, the method comprising:
beginning with a first node of the plurality of nodes, iteratively determining link information corresponding to each physical link of each node of the plurality of nodes;
in response to determining the link information for each node, sequentially numbering each node excepting the first node;
maintaining the link information and associated node number information in a data structure;
assigning node groups based upon which nodes are physically connected together such that no node belonging to one group belongs to another group;
determining a correct node numbering based upon the node groups such that the node numbers are contiguous in each grouping of nodes, and from one group of nodes to a next group of nodes; and
updating the data structure based upon the correct node numbering.

2. The method as recited in claim 1, further comprising renumbering the nodes according to the updated data structure.

3. The method as recited in claim 1, wherein the updated data structure corresponds to the routing map of the plurality of nodes.

4. The method as recited in claim 1, wherein determining link information includes a given node sending a request packet via an outbound physical link and waiting for a reply packet that includes the physical link number of a corresponding inbound link.

5. The method as recited in claim 1, further comprising renumbering the nodes such that the node numbers are contiguous from one plane of nodes to a next plane of nodes.

6. The method as recited in claim 1, wherein renumbering the nodes includes the first node sending a write request packet including a node ID to a configuration register of each node to be renumbered.

7. A computer readable storage medium comprising program instructions executable by a processor to:
establish a routing map of a computer system including a plurality of nodes interconnected by a plurality of physical links by:
beginning with a first node of the plurality of nodes and iteratively determining link information corresponding to each physical link of each node of the plurality of nodes;
sequentially numbering each node excepting the first node, in response to determining the link information for each node;
maintaining the link information and associated node number information in a data structure;
assigning node groups based upon which nodes are physically connected together such that no node belonging to one group belongs to another group;
determining a correct node numbering based upon the node groups such that the node numbers are contiguous in each grouping of nodes, and from one group of nodes to a next group of nodes; and
updating the data structure based upon the correct node numbering.

8. The computer readable storage medium as recited in claim 7, wherein the program instructions are further executable by a processor to establish a routing map by renumbering the nodes according to the updated data structure.

9. The computer readable storage medium as recited in claim 7, wherein the updated data structure corresponds to the routing map of the plurality of nodes.

10. The computer readable storage medium as recited in claim 7, wherein determining link information includes a given node sending a request packet via an outbound physical link and waiting for a reply packet that includes the physical link number of a corresponding inbound link.

11. The computer readable storage medium as recited in claim 7, wherein the program instructions are further executable by a processor to establish a routing map by renumbering the nodes such that the node numbers are contiguous from one plane of nodes to a next plane of nodes.

12. The computer readable storage medium as recited in claim 7, wherein renumbering the nodes includes the first node sending a write request packet including a node ID to a configuration register of each node to be renumbered.

13. A computer system comprising:
a plurality of processing nodes interconnected via a plurality of physical links; and
a storage medium coupled to a particular node of the plurality of processing nodes and configured to store initialization program instructions;
wherein the particular node is configured to establish a routing map corresponding to an interconnection of the plurality of processing nodes by executing the initialization program instructions;
wherein the particular node is configured to:
begin with a first node of the plurality of nodes and iteratively determine link information corresponding to each physical link of each node of the plurality of nodes;
sequentially number each node excepting the first node, in response to determining the link information for each node;
maintain the link information and associated node number information in a data structure;
assign node groups based upon which nodes are physically connected together such that no node belonging to one group belongs to another group;
determine a correct node numbering based upon the node groups such that the node numbers are contiguous in each grouping of nodes, and from one group of nodes to a next group of nodes; and
update the data structure based upon the correct node numbering.

14. The computer system as recited in claim 13, the particular node is further configured to renumber the nodes according to the updated data structure.

15. The computer system as recited in claim 13, wherein the updated data structure corresponds to the routing map of the plurality of nodes.

16. The computer system as recited in claim 13, wherein each node is configured to send a request packet via an outbound physical link and to wait for a reply packet that includes the physical link number of a corresponding inbound link.

17. The computer system as recited in claim 13, wherein the particular node is further configured to renumber the nodes such that the node numbers are contiguous from one plane of nodes to a next plane of nodes.

18. The computer system as recited in claim 13, wherein the first node is configured to send a write request packet including a node ID to a configuration register of each node to be renumbered.

19. The computer system as recited in claim 13, wherein the first node comprises a bootstrap node.

20. The computer system as recited in claim 19, wherein a node ID of the bootstrap node is 00h, and each other node is set to a same default value in response to a reset.
